(19) United States
(12) Patent Application Publication
(10) Pub. No.: US 2026/0154139 A1
(43) Pub. Date: Jun. 4, 2026

(54) API EVALUATION SYSTEM AND STORAGE MEDIUM STORING PROGRAM

(71) Applicant: DENSO CORPORATION, Kariya-city (JP)

(72) Inventors: Seiji MURATA, Kariya-city (JP); Yukihiro YAMAKAWA, Kariya-city (JP); Hideyuki YAMAGUCHI, Kariya-city (JP)

(21) Appl. No.: 19/455,579

(22) Filed: Jan. 21, 2026

Related U.S. Application Data
(63) Continuation of application No. PCT/JP2024/026152, filed on Jul. 22, 2024.

(30) Foreign Application Priority Data
Jul. 27, 2023 (JP) 2023-122458

(51) Int. Cl. G06F 9/54

(52) U.S. Cl. CPC G06F 9/544

(57) ABSTRACT

An application programming interface evaluation system comprises: an information acquisition unit configured to acquire an application programming interface access log representing a use status of an application programming interface for providing a vehicle function according to a request from an application installed in a vehicle; a sales-related index generation unit configured to generate a sales-related index indicating a degree of an influence of the application programming interface on the application and a user of the vehicle; and an output unit configured to output the sales-related index.

### CROSS REFERENCE TO RELATED APPLICATIONS

The present application is a continuation application of International Patent Application No. PCT/JP2024/026152 filed on Jul. 22, 2024, which designated the U.S. and claims the benefit of priority from Japanese Patent Application No. 2023-122458 filed on Jul. 27, 2023. The entire disclosures of all of the above applications are incorporated herein by reference.

### TECHNICAL FIELD

The present disclosure relates to a technology for evaluating API.

### BACKGROUND

A technology for extracting an occurrence part of incompatibilities for an application platform and providing a method for resolving the incompatibilities has been known as a comparative example.

### SUMMARY

According to an aspect of the present disclosure, an application programming interface evaluation system comprises at least one of (i) a circuit and (ii) a processor with a memory storing computer program code executable by the processor, the at least one of the circuit and the processor configured to cause the application programming interface evaluation system to: acquire an application programming interface access log representing a use status of an application programming interface for providing a vehicle function according to a request from an application installed in a vehicle; generate a sales-related index indicating a degree of an influence of the application programming interface on the application and a user of the vehicle; and output the sales-related index.

### BRIEF DESCRIPTION OF DRAWINGS

FIG. 1 is a block diagram showing a hardware configuration of an API evaluation system.

FIG. 2 is a block diagram showing a functional configuration of an API evaluation system.

FIG. 3 is an explanatory diagram showing contents of an application operation log.

FIG. 4 is a flowchart of an application log management process.

FIG. 5 is an explanatory diagram showing contents of an API access log.

FIG. 6 is a flowchart of an API log management process.

FIG. 7 is an explanatory diagram showing the contents of application information managed by an application store.

FIG. 8 is an explanatory diagram showing the contents of information representing the influence on security protection assets managed by the application store.

FIG. 9 is an explanatory diagram showing an API access log with additional information accumulated in an application store.

FIG. 10 is an explanatory diagram showing the contents of vehicle sales data managed by a vehicle sales DB.

FIG. 11 is a flowchart of an API index calculation process.

FIG. 12 is an explanatory diagram of a basic API index.

FIG. 13 is an explanatory diagram showing a method of aggregating API access logs used when calculating API indices that takes into account an application use situation.

FIG. 14 is an explanatory diagram showing an example of calculating an API index that takes into account the number of application downloads.

FIG. 15 is an explanatory diagram showing an example of calculating an API index that takes into account application evaluation.

FIG. 16 is an explanatory diagram showing a method of aggregating API access logs used when calculating the API index that takes into account vehicle sales data.

FIG. 17 is an explanatory diagram showing an example of calculating the API index that takes into account the vehicle sales data.

FIG. 18 is an explanatory diagram showing an example of calculating the API index that takes into account the influence on the security protection asset.

### DETAILED DESCRIPTION

A vehicle function is provided via an application programming interface (hereinafter referred to as API). The API will be upgraded as appropriate to accommodate configuration changes of sensors, actuators, ECUs, and the like to implement functions, and to support an increase in the number of supported OEM and vehicle model variations, and to improve ease of use. It is desirable that the upgraded APIs have backward compatibility so that it can be used without modification to existing applications.

However, it takes a huge amount of time to continue to maintain backward compatibility of all APIs, so it is necessary to appropriately select APIs that maintain backward compatibility and efficiently develop the APIs.

In the technology, information for resolving the incompatibility is only obtained, and it is not possible to determine whether it is really necessary to maintain the compatibility.

One aspect of the present disclosure provides a technology for evaluating API for maintaining backward compatibility.

According to one aspect of the present disclosure, an API evaluation system comprises an information acquisition unit, a sales-related index generation unit, and an output unit. The information acquisition unit acquires an application programming interface access log representing a use status of an application programming interface that is an interface for providing a vehicle function according to a request from an application installed in a vehicle. The sales-related index generation unit generates a sales-related index according to a log aggregation value that is a result of aggregating the application programming interface access log for each vehicle classification obtained by classifying the vehicle based on vehicle sales data related to sales of the vehicle and for each application programming interface type. The sales-related index is an application programming interface index that indicates the degree of the influence of application programming interface on the application and a vehicle user. The output unit outputs the sales-related index.

According to such a configuration, it is possible to select the API that should be prioritized for maintaining backward compatibility using the generated sales-related index, and efficiently develop the API.

According to one aspect of the present disclosure, an API evaluation system comprises an access log storage, a sales data storage, an information acquisition unit, a sales-related index generation unit, and an output unit. The access log storage collects from a vehicle and store an application programming interface access log representing a use status of an application programming interface that is an interface for providing a vehicle function according to a request from an application installed in the vehicle. The sales data storage accumulates vehicle sales data related to vehicle sales. The information acquisition unit acquires the application programming interface access log and vehicle sales data from the access log storage and the sales data storage. The sales-related index generation unit generates a sales-related index according to a log aggregation value that is a result of aggregating the application programming interface access log for each vehicle classification obtained by classifying the vehicle based on the vehicle sales data and for each application programming interface type. The sales-related index is an application programming interface index that indicates the degree of the influence of application programming interface on the application and a vehicle user. The output unit outputs the sales-related index.

According to such a configuration, it is possible to select the API that should be prioritized for maintaining backward compatibility using the generated sales-related index, and efficiently develop the API.

According to one aspect of the present disclosure, a program causes a computer to function as an information acquisition unit, a sales-related index generation unit, and an output unit.

By executing such a program, it is possible to obtain the same effect as the API evaluation system described above.

Hereinafter, an embodiment of the present disclosure will be described with reference to the drawings.

### 1. Configuration

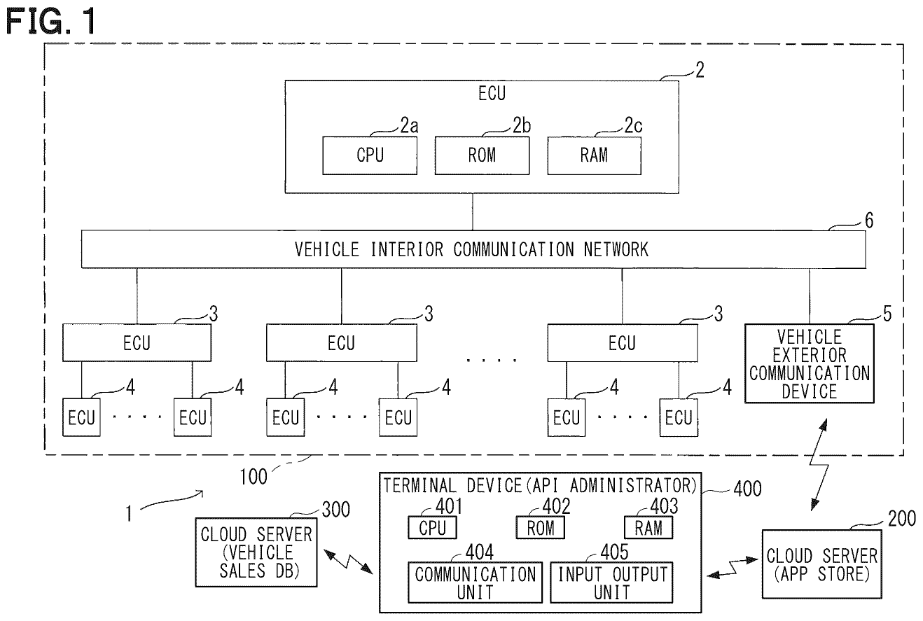

As shown in FIG. 1, an API evaluation system 1 of the present embodiment includes an in-vehicle system 100 mounted on a vehicle, an application store 200, a vehicle sales DB 300, and a terminal device 400. The DB is an abbreviation for database. The vehicle may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the travel driving source. Hereinafter, the vehicle equipped with the in-vehicle system 100 will be simply referred to as a vehicle.

The in-vehicle system 100 includes one electronic control unit (hereinafter referred to as ECU) 2, multiple ECUs 3, multiple ECUs 4, a vehicle exterior communication device 5, and a vehicle interior communication network 6. The ECU is an abbreviation for Electronic Control Unit.

The ECU 2 controls the multiple ECUs 3 to achieve coordinated control of the entire vehicle.

The ECU 3 is provided for each domain divided by function in the vehicle, and mainly controls multiple ECUs 4 existing within that domain. Each ECU 3 is connected to a subordinate ECU 4 via a lower layer network that is individually placed. As the lower layer network, for example, a Controller Area Network (hereinafter, referred to as CAN) is used. The CAN is a registered trademark. The ECU 3 has a function of centrally managing access privilege to the subordinate ECU 4, authenticating users, and the like. The domain includes, for example, a powertrain, a body, a chassis, a cockpit, and the like.

The ECUs 4 connected to the ECU 3 belonging to the powertrain domain include, for example, an ECU 4 that controls an engine, an ECU 4 that controls a motor, and an ECU 4 that controls a battery.

The ECUs 4 connected to the ECU 3 belonging to the body domain include, for example, an ECU 4 that controls an air conditioner and an ECU 4 that controls doors.

The ECUs 4 connected to the ECU 3 belonging to the chassis domain include, for example, an ECU 4 that controls the brakes and an ECU 4 that controls the steering.

The ECUs 4 connected to the ECU 3 belonging to the cockpit domain include, for example, an ECU 4 that controls the display of meters and navigation, and an ECU 4 that controls HMI devices operated by vehicle occupants. The HMI is an abbreviation for Human Machine Interface.

The vehicle exterior communication device 5 performs data communication with vehicle exterior devices such as the application store 200 via a wide area wireless communication network.

The vehicle interior communication network 6 includes a CAN with Flexible Data Rate (hereinafter, referred to as CAN FD) and Ethernet. The Ethernet is a registered trademark. The CAN FD may connect the ECU 2 to each ECU 3 and the vehicle exterior communication device 5 via a bus. The Ethernet may connect the ECU 2 and each ECU 3 and the vehicle exterior communication device 5 individually.

The ECU 2 is an electronic control unit mainly including a microcomputer including a CPU 2a, a ROM 2b, a RAM 2c, and the like. Various functions of the microcomputer are implemented by the CPU 2a executing programs stored in a non-transitory tangible storage medium. In this example, the ROM 2b corresponds to a non-transitory tangible storage medium that stores a program. Further, by executing this program, a method corresponding to the program is executed. Note that partial or all of the functions executed by the CPU 2a may be implemented by a hardware circuit, such as one or more ICs. Further, the number of the microcomputers constituting the ECU 2 may be one or more.

The ECU 3, the ECU 4, and the vehicle exterior communication device 5 are all electronic control units mainly including a microcomputer provided with a CPU, ROM, RAM, and the like, similarly to the ECU 2. Further, the number of the microcomputers constituting the ECU 3 and ECU 4, and the vehicle exterior communication device 5 may be one or more.

Hereinafter, unless otherwise specified, the ECU 2, ECU 3, ECU 4, and the vehicle exterior communication device 5 will be collectively referred to as in-vehicle devices 2 to 5.

The application store 200 and the vehicle sales DB 300 are all electronic control units mainly including a microcomputer provided with a CPU, ROM, RAM, and the like, similarly to the ECU. Various functions of the microcomputer are implemented by causing the CPU to execute programs stored in a non-transitory tangible storage medium. In this example, the ROM corresponds to a non-transitory tangible storage medium in which the programs are stored. Further, by executing this program, a method corresponding to the program is executed. Note that partial or all of the functions executed by the CPU may be implemented by a hardware circuit, such as one or more ICs. Further, the number of the microcomputers constituting the ECU may be one or more.

The application store 200 is a cloud server that can communicate with at least the in-vehicle system 100 and the terminal device 400, and manages service applications (hereinafter also referred to as apps) executed by the in-vehicle system 100. The application store 200 sells applications to be installed in the in-vehicle system 100, and collects, from the in-vehicle system 100 in which the application is installed, an application operation log indicating the operation status of the application and an API access log indicating the status of an access from the applications to the API. Furthermore, the application store 200 generates application use fee collection data, API use fee collection data, and the like based on the application operation log and API access log. The application use fee collection data is data for collecting the application use fee from an application purchaser (hereinafter referred to as a user). The API use fee collection data is data for collecting API use fees from application developers or operators (hereinafter referred to as servicers).

The vehicle sales DB 300 is a cloud server capable of communicating with at least the terminal device 400, accumulating data related to vehicle sales, and providing the accumulated data in response to a request from the terminal device 400 or the like.

The terminal device 400 is an electronic control unit mainly having a microcomputer including a CPU 401, ROM 402, RAM 403, and the like. Various functions of the microcomputer are implemented by causing the CPU 401 to execute programs stored in a non-transitory tangible storage medium. In this example, the ROM 402 corresponds to the non-transitory tangible storage medium in which the program is stored. Further, by executing this program, a method corresponding to the program is executed. Note that partial or all of the functions executed by the CPU 401 may be implemented by a hardware circuit, such as one or more ICs. Further, the number of the microcomputers constituting the terminal device 400 may be one or more.

The terminal device 400 further includes a communication unit 404 and an input output unit 405. The communication unit 404 performs data communication with the application store 200, the vehicle sales DB 300, and the like via a wide area wireless communication network. The input output unit 405 includes various input devices for accepting input by an operator of the terminal device 400 and various output devices for presenting results of processes and the like by the terminal device 400 to the operator. The input device may include a keyboard, a pointing device, a touch panel, a microphone, and the like. The output device may include a display, a speaker, a printer, and the like.

The terminal device 400 executes at least an index calculation process. The index calculation process is a process of collecting information from the application store 200 and the vehicle sales DB 300 and calculating the API index. The API index is an index used for evaluating each API to determine a prioritized API and whether to maintain backward compatibility when updating the API installed in the vehicle. Details of the index calculation process will be described later.

### 2. Functional Configuration

Various functions of the API evaluation system 1 will be described.

### (2-1. In-Vehicle System)

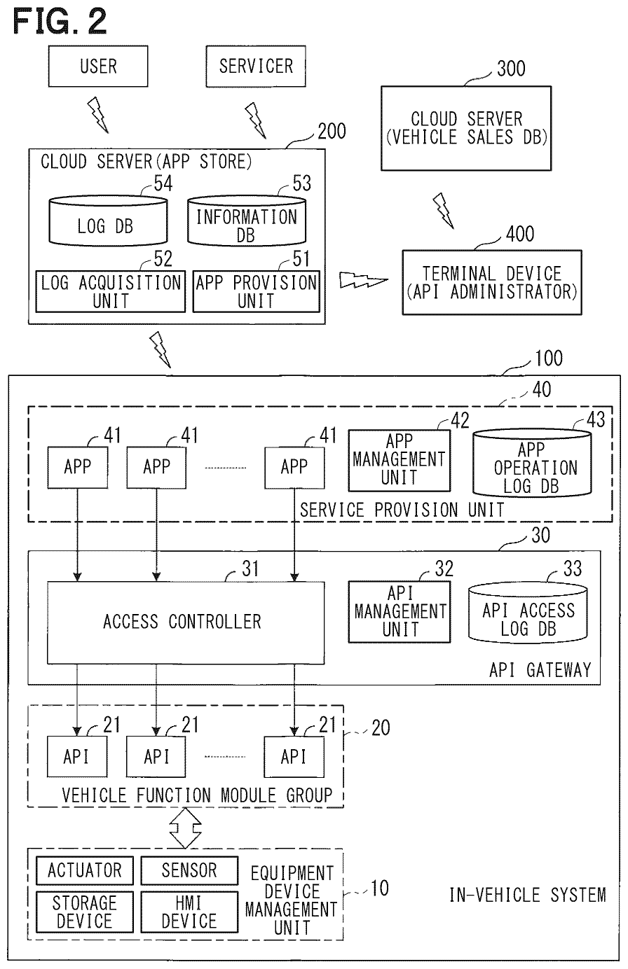

As shown in FIG. 2, the in-vehicle system 100 has functions as an equipment device management unit 10, a vehicle function module group 20, an API gateway 30, and a service provision unit 40. The functions provided by the in-vehicle system 100 are distributed among the in-vehicle devices 2 to 5 belonging to the in-vehicle system 100.

### (2-1-1. Equipment Device Management Unit)

The equipment device management unit 10 manages multiple types of vehicle equipment device mounted on the vehicle.

The equipment device management unit 10 operates the vehicle equipment device according to the operation instruction from the vehicle function module group 20, and notifies the vehicle function module group of the operation result. The vehicle equipment device may include actuators, sensors, storage devices, HMI equipment, and the like. For example, when the vehicle equipment device is the actuator, the operation result may indicate that an operation of the actuator is completed normally or abnormally. When the vehicle equipment device is a sensor, the operation result may indicate data detected by the sensor. When the vehicle equipment device is a storage device, the notified result may include data read from the storage device.

The equipment device management unit 10 may be configured to operate the vehicle equipment device in accordance with an operation instruction output from the vehicle function module group 20, as well as to automatically detect the state of vehicle equipment device and provide the notification to the vehicle function module group.

### (2-1-2. Vehicle Function Module Group)

The vehicle function module group 20 is a collection of vehicle function modules that are modules executing processes for implementing various functions using the vehicle equipment device. The functions of the vehicle function modules are provided via an application programming interface (hereinafter referred to as API) 21. The vehicle function modules may be classified by vehicle operation that is easily requested by the service provision unit 40 into, for example, state recognition, motion system equipment device control, Human Machine Interface (hereinafter referred to as HMI) system equipment device control, body system equipment device control, and the like.

The state recognition corresponds to an operation of recognizing a situation of the vehicle itself and the periphery of the vehicle, such as the positions of the vehicle and pedestrians. A control target of the vehicle function module classified as state recognition is, for example, a vehicle equipment device (for example, a camera, a millimeter wave sensor, or the like) belonging to recognition control.

The motion system equipment device control corresponds to operations such as turning, traveling, and stopping of the vehicle. A control target of the vehicle function module classified as motion system equipment device control is, for example, a vehicle equipment device (for example, actuator) belonging to brake control and steering control.

The HMI system equipment device control responds to vehicle operations related to the presentation of information to the user. The vehicle function module classified as the HMI system equipment device control is, for example, a vehicle equipment device (for example, a display, a speaker, or the like) belonging to display control and audio control.

The body system equipment device control corresponds to the body system vehicle operation related to the vehicle environment. A control target of the vehicle function module classified as the body system equipment device control is, for example, a vehicle equipment device (for example, actuator) belonging to light control, HVAC control, and seat control. The HVAC is an acronym for heating, ventilation, and air conditioning, collectively referred to as an air conditioning system.

### (2-1-3. Service Provision Unit)

The service provision unit 40 executes an application 41, which is downloaded from the application store 200 and installed, to implement various functions, such as, for example, information collection, theft prevention, and remote control by utilizing the vehicle equipment device, which is managed by the equipment device management unit 10. There may be multiple applications 41.

Basically, by using the API 21, the application 41 accesses the vehicle function modules belonging to the vehicle function module group 20 via the API gateway 30 to utilize the functions of various vehicle equipment devices and implement the intended services.

The user can purchase the application 41 from the application store 200. The application purchased from the application store 200 is installed in any one of the in-vehicle devices 2 to 5. Further, the user can update or delete the applications 41 installed in the in-vehicle devices 2 to 5 as appropriate.

Note that in the case of an application used to provide a service that acquires vehicle information from many vehicles and analyzes vehicle behavior, driver driving operations, and the like, the servicer, which is the provider of the application 41, may install the application 41 in any of the in-vehicle devices 2 to 5 with the permission of the vehicle user.

The application 41 may be installed not only in any of the in-vehicle devices 2 to 5, but also in an external device remotely connected to the vehicle interior communication network 6 via the vehicle exterior communication device 5.

The service provision unit 40 includes an application management unit 42 and an application operation log DB 43.

The application management unit 42 generates an application operation log based on the result of monitoring the operation status of the application 41 installed in the vehicle, accumulates it in the application operation log DB 43, and appropriately executes a process of uploading the accumulated application operation log to the application store 200. The application management unit 42 and the application operation log DB 43 may be distributed and placed in all the in-vehicle devices 2 to 5 where the application 41 may be installed, or may be integrated and placed in any one of the in-vehicle devices 2 to 5.

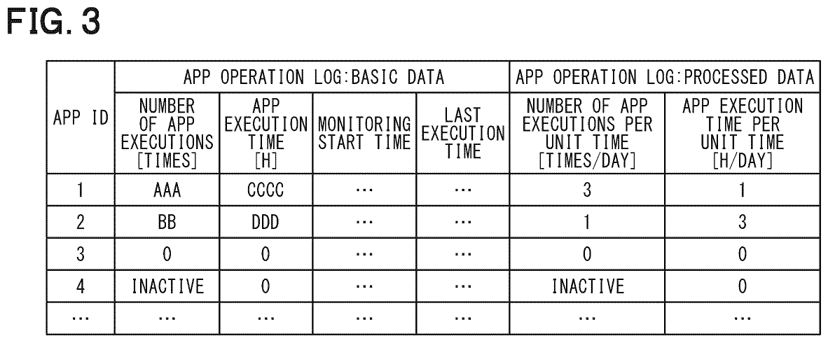

The application operation log accumulated in the application operation log DB 43 is stored in association with an “application ID” as shown in FIG. 3. The “application ID” is an identifier of the application 41 provided from the application store 200. The application operation log is classified into basic data and processed data. The basic data is updated as needed according to the operation status of the application 41. The processed data is generated when the application operation log is uploaded to the application store 200. Only basic data may be stored in the application operation log DB 43.

Hereinafter, the application identified by the “application ID” is referred to as the target application.

The basic data includes “number of application executions”, “application execution time”, “monitoring start time”, and “last execution time”. The “number of application executions” is the number of times the target application has been activated in the in-vehicle system 100. The “application execution time” is the time when the target application was executed in the in-vehicle system 100. The “monitoring start time” represents the time when the count of the “number of application executions” and the integration of “application execution times” start for the target application. The “last execution time” represents the time when the target application was last executed. Note that the “number of application executions” is set to a value indicating that the target application is inactive when the elapsed time from the time indicated by the “last execution time” to the current time is longer than a preset inactivity allowable time.

The processed data includes “number of application executions per unit time” and “application execution times per unit time”. The “number of application executions per unit time” is calculated according to, in the basic data, the “number of application executions” and a period (hereinafter referred to as a monitoring period) from the time indicated by the “monitoring start time” to the upload execution time. The “application execution time per unit time” is calculated according to the “application execution time” and the monitoring period included in the basic data. The unit time may be, for example, per 24 hours, that is, per day. The processed data is data normalized so as to be able to be simply integrated when aggregating the “number of application executions” and “application execution times” uploaded from many in-vehicle systems 100 to the application store 200.

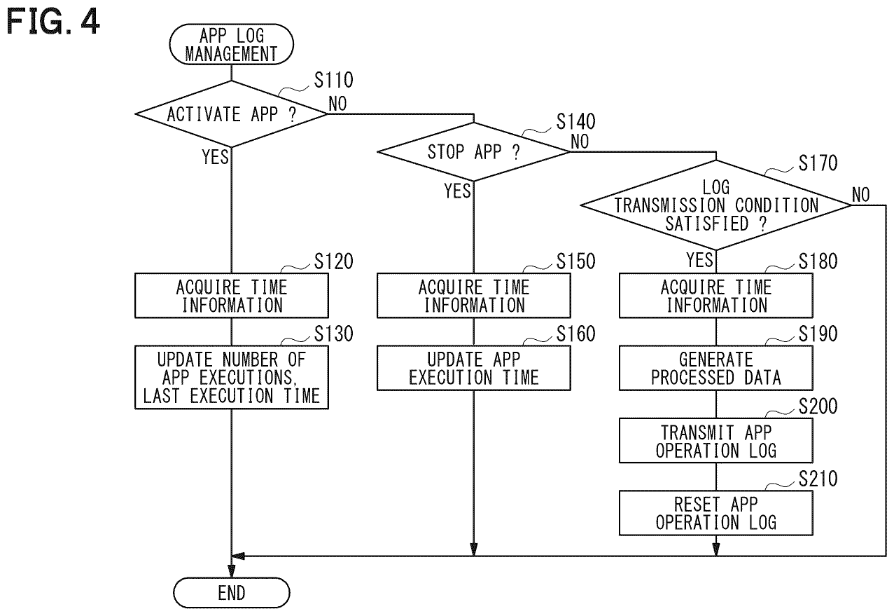

Next, the application log management process executed by the application management unit 42 will be described with reference to a flowchart of FIG. 4.

The application log management process is repeatedly executed when the in-vehicle system 100 is activated.

In S110, the application management unit 42 determines whether the application 41 belonging to the service provision unit 40 has been activated. When the application 41 has been activated, the process proceeds to S120. When the application 41 has not been activated, the process proceeds to S140.

In S120, the application management unit 42 acquires time information indicating the current time (i.e., the time when the application 41 was activated).

In the next S130, the application management unit 42 updates the “number of application executions” and the “last execution time” of the activated application 41 in the application operation logs stored in the application operation log DB 43, and ends the process. Specifically, the application management unit 42 updates the “number of application executions” by counting up by 1, and updates the “last execution time” with the time information acquired in S120.

In S140, the application management unit 42 determines whether the application 41 belonging to the service provision unit 40 has stopped. When the application 41 has stopped, the process proceeds to S150. When the application 41 has not stopped, the process proceeds to S170.

In S150, the application management unit 42 acquires time information indicating the current time (i.e., the time when the application 41 stopped).

In the next S160, the application management unit 42 updates the “application execution time” of the application operation log stored in the application operation log DB 43 for the stopped application 41, and ends the process. Specifically, the application management unit 42 performs update by adding the time from the activation to the stop of the application 41 to the “application execution time” stored in the application operation log DB 43, the time being calculated according to the time information acquired in S120 and S150.

In S170, the application management unit 42 determines whether the log transmission condition of the application operation log is satisfied. When the log transmission condition is satisfied, the process proceeds to S180. When the log transmission condition is not satisfied, the process ends. The log transmission condition of the application operation log may be that a certain period (for example, a day, a week, or a month) has elapsed, that it is a specified date, or that an upload instruction is received from the application store 200.

In S180, the application management unit 42 acquires time information representing the current time (i.e., the time at which the application operation log is uploaded).

In the next S190, the application management unit 42 generates the processed data in accordance with the basic data of the application operation log stored in the application operation log DB 43. Specifically, the monitoring time from the time indicated by the “monitoring start time” of the basic data to the current time indicated by the time information acquired in S180 is calculated. Then, by dividing the “number of application executions” by the monitoring time, the “number of application executions per unit time” is calculated, and by dividing the “application execution time” by the monitoring time, the “application execution time per unit time” is calculated. Further, the inactivity time from the time indicated by the “last execution time” to the current time indicated by the time information acquired in S180 is calculated. Then, when the calculated inactivity time exceeds the allowable time, values indicating inactivity are set in the “number of application executions” and the “number of application executions per unit time” of the basic data.

In the next S200, the application management unit 42 transmits (that is, uploads) the application operation log to the application store 200 together with the time information acquired in S180. The application operation log to be uploaded may be all of the basic data and processed data, only the basic data, or only the processed data. When uploading only the basic data, the application store 200 may generate the processed data.

In the next S210, the application management unit 42 resets the “number of application executions”, “application execution time”, and “monitoring start time” of the basic data of the application operation log stored in the application operation log DB 43, and ends the process. Specifically, the “number of application executions” and the “application execution time” are zero-cleared, and the “monitoring start time” is set to the time information acquired in S180.

Here, the case where the upload timing of the application operation log is the same for all applications 41 has been described. However, the upload timing may be different for each application 41.

### (2-1-4. API Gateway)

Returning to FIG. 2, the API gateway 30 provides an interface that connects the applications 41, and an interface that connects the application 41 and the hardware. The API gateway 30 includes an access controller 31, an API management unit 32, and an API access log DB 33.

When the access controller 31 receives an API access request (hereinafter referred to as an API call) from the application 41, it determines whether the API call can be accepted from a formal perspective, such as the request format and the access privilege of the caller. When the access controller 31 determines that the API call can be accepted, it transfers the API call to the vehicle function module group 20. More specifically, the API call is transferred to the in-vehicle devices 2 to 5 that have the vehicle function module that implements the process based on the API call. Further, the access controller 31 transfers, to the calling application 41, the response (hereinafter referred to as API response) to the API call obtained from the vehicle function module group 20. When the access controller 31 determines that the API call cannot be accepted, it discards the API call. In this case, the calling source application 41 may be notified of the abandonment of the API call.

The API management unit 32 monitors the operation of the access controller 31, generates an API access log, and executes a process of accumulating the generated API access log in the API access log DB 33. In addition, the API management unit 32 appropriately executes a process of uploading the API access logs accumulated in the API access log DB 33 to the application store 200.

The API access log may utilize information recorded for billing purposes for the calling source application 41 that made the API call.

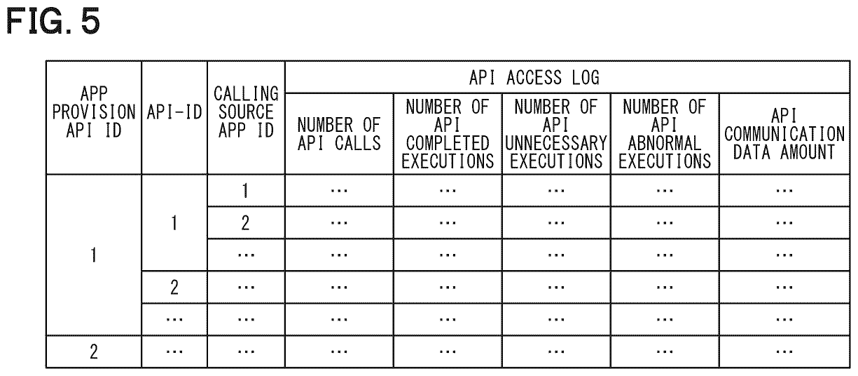

As shown in FIG. 5, the API access logs stored in the API access log DB 33 are classified and stored for each “API provision application ID”, each “API-ID”, and each “calling source application ID”.

The “API provision application ID” is the identifier of the API provision application. The API provision application is a vehicle function module that provides API. Since the same API may be provided by multiple API provision applications, the API provision application to which the used API belongs is identified by the “API provision application ID”. When the same API is provided by multiple API provision applications, the API belonging to the API provision application is selected so that the communication cost is lower, for example. The “API-ID” is an identifier of the API. The “calling source application ID” is an identifier of the calling source application 41 that is the application that made the API call.

The API access log includes information such as the “number of API calls”, the “number of completed API executions”, the “number of API unnecessary executions”, the “number of abnormal API executions”, and the “API communication data amount”.

The “number of API calls” is the number of times the API call is made. The “number of completed API executions” is the number of times the API call has been normally completed and the requested operation has been completed. The “number of API unnecessary executions” is the number of times the API call has been normally completed, but the requested operation has already been achieved, and the operation has been cancelled. For example, when a request to open a window is received but the window is already released, the count is made. The “number of abnormal API executions” is the number of times the API call is not normally completed or the number of times the API call is normally completed but the requested operation is not achieved. The “API data communication amount” is the integrated value of the data amount acquired by the calling source application 41 through the API call.

In other words, the API access log records which application used which API, how many times it was used, and what the result of the use was.

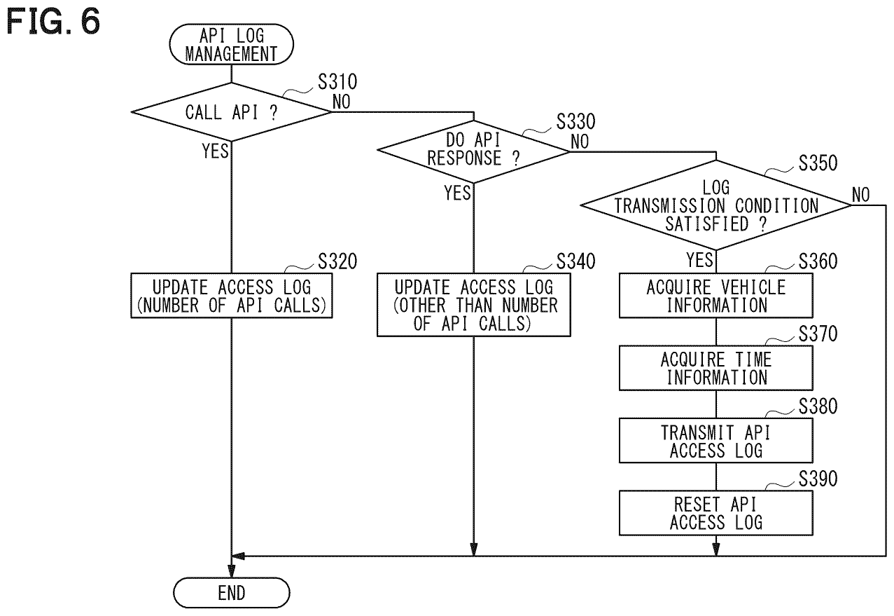

Next, the API log management process executed by the API management unit 32 will be described with reference to a flowchart of FIG. 6.

The log management process is repeatedly executed when the in-vehicle system 100 is activated.

In S310, the API management unit 32 determines whether the API call has been accepted by the access controller 31. When it has been accepted, the process proceeds to S320. When it has not been accepted, the process proceeds to S330. Note that the API call includes at least information about “API provision application ID”, “API-ID”, and “calling source application ID”.

In S320, the API management unit 32 updates the “number of API calls” in the API access log stored in the API access log DB 33 for the API that has been called, and then ends the process. Specifically, the value of the “number of API calls” is counted up by one.

In S330, the API management unit 32 determines whether the API response has been transferred by the access controller 31, and when the API response has been transferred, the process proceeds to S340. When the API response has not been transferred, the process proceeds to S350.

In S340, the API management unit 32 updates the API access log stored in the API access log DB 33 for the API to which the API response has been transferred in accordance with the content of the API response, and ends the process. Specifically, when the API response indicates that the process based on the API call has been normally completed, the API management unit 32 updates the “number of completed API executions”. When the API response indicates that the process based on the API call did not complete normally, the “number of abnormal API executions” is updated. Further, even when the process based on the API call has been normally completed, when the requested operation is unnecessary, the “number of API unnecessary executions” is updated. Furthermore, when the data communication is performed by the process based on the API call, the “API communication data amount” is updated.

In S350, the API management unit 32 determines whether the log transmission condition of the API access log is satisfied. When the log transmission condition is satisfied, the process proceeds to S360. When the log transmission condition is not satisfied, the process ends. The log transmission conditions of the API access log may be the same as or different from the log transmission conditions of the application operation log.

In S360, the API management unit 32 acquires vehicle information including information about the vehicle type and destination country of the subject vehicle. The destination country is information representing a sales region of the vehicle. The vehicle information is acquired information stored in an information source (for example, a body type ECU). The vehicle information may be acquired using API or by another method other than API. The vehicle information may be acquired from the information source each time, or may be acquired only once from the information source at the time of activating the vehicle and stored in the API access log DB 33 or the like, and thereafter may be acquired from the API access log DB 33.

In the next S370, the API management unit 32 acquires time information indicating the current time (i.e., the time at which the API access log is uploaded).

In the next S380, the API management unit 32 transmits (that is, uploads) data to the application store 200. The transmitted data is obtained by adding the vehicle information acquired in S360 and the time information acquired in S370 to the API access log stored in the API access log DB 33.

In the next S390, the API management unit 32 resets the API access log and ends the process. In the reset API access log, the values of all items are zero-cleared.

### (2-2. Application Store)

Returning to FIG. 2, the application store 200 includes an application provision unit 51, a log acquisition unit 52, an information DB 53, and a log DB 54.

The application provision unit 51 downloads the application 41 stored in the information DB 53 to the in-vehicle system 100 or the like in response to a request from the user or the servicer. The application provision unit 51 accumulates the aggregation value obtained by aggregating the number of downloads of each application 41 for each application ID in the information DB 53 as part of the application information.

In addition to the application 41 and application information, the information DB 53 stores API security protection asset data.

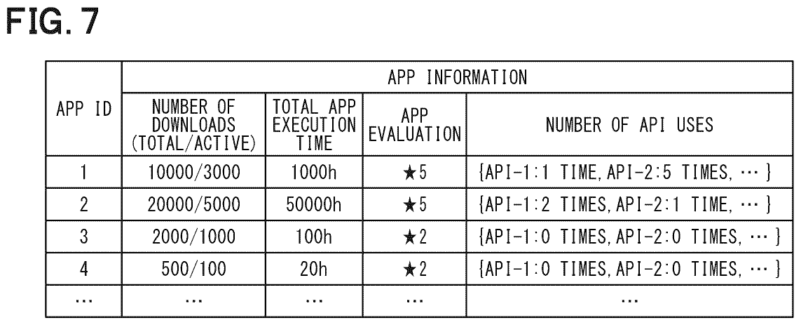

As shown in FIG. 7, the application information is classified by “application ID” and has items such as “number of downloads”, “total application execution time”, “application evaluation”, and “number of API uses”.

The “number of downloads” indicates a cumulative value that counts the number of downloads of the target application that is the application 41 identified by the “application ID” and the number of actives that represents the number of substantially running applications. The number of actives is a log aggregation value that aggregates the number of target applications that are not indicated as inactive in the “number of application executions” or “number of application executions per unit time” included in the application operation log. That is, the cumulative value of the number of downloads is updated each time the application 41 is downloaded, and the number of actives is updated each time the application operation log is uploaded.

The “total application execution time” is a log aggregation value that aggregates the “application execution time” included in the application operation log for the target application. That is, the “total application execution time” is updated each time the application operation log is uploaded.

The “application evaluation” is information indicating the application evaluation by the user. The “application evaluation” is, for example, a result obtained by aggregating application evaluations collected on application evaluation sites or the like. That is, the “application evaluation” is updated when the aggregated result of the evaluation is acquired.

The “number of API uses” is information indicating the number of API calls to be made for each API of all APIs used in the target application. The “number of API uses” is not the number of times the API is actually used, but the number of times the target application makes an API call, and is applied by the servicer that registers the target application in the application store 200.

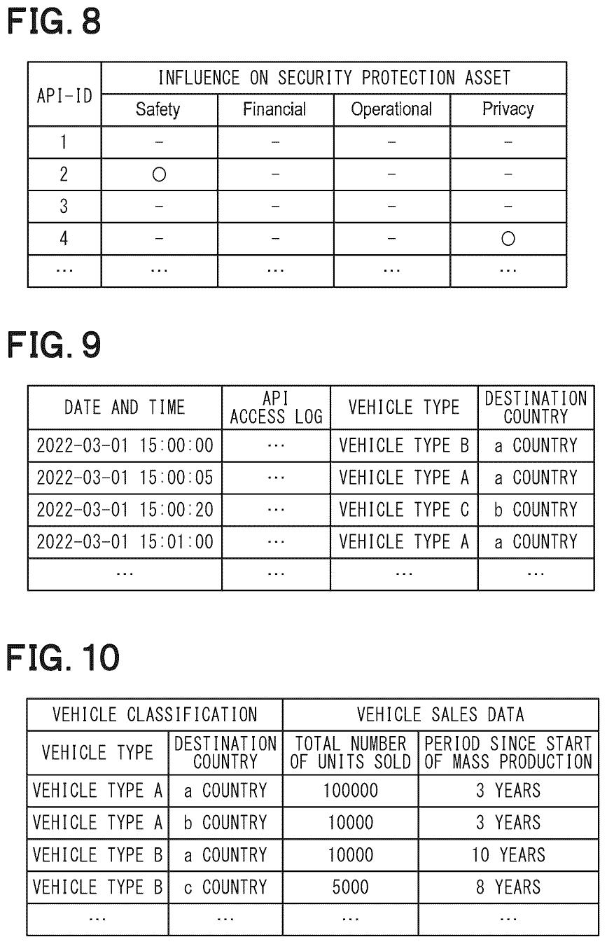

The API security protection asset data is data that associates the “API-ID” and the “security protection asset data” as shown in FIG. 8. The “security protection asset data” is set in terms of S.F.O.P, which is an attribute defined as the security protection asset. The S is an abbreviation for Safety, and means API that provides functions that affect safety. The F is an abbreviation for Financial, and means API that provides functions that affect corporate or personal assets. The “O” is an abbreviation for “Operational” and means API that provides functions that affect the operational performance of the vehicle. The P is an abbreviation for Privacy, and means API that provides functions that affect privacy information. The API security protection asset data is generated by the manufacturer of the API provision application or the like. In a table shown in FIG. 8, circles indicate there is the effect.

The log acquisition unit 52 sequentially accumulates the application operation log and the API access log uploaded from the in-vehicle system 100 in the log DB 54, and updates the “number of downloads” and the “total application execution time” of the application information shown in FIG. 7 based on the application operation log. For the application operation log, both the basic data and the processed data may be accumulated, or only processed data may be accumulated.

Further, as shown in FIG. 9, the “API access log” is stored in the log DB 54 together with the “upload time”, “vehicle type”, and “destination country” uploaded from the in-vehicle system 100 together with the “API access log”. The “API access log” in FIG. 9 includes the entire table shown in FIG. 5.

### (2-3. Vehicle Sales DB)

The vehicle sales DB 300 is a cloud server that accumulates vehicle sales data, and provides the accumulated vehicle sales data in response to a request from the terminal device 400 or the like.

As shown in FIG. 10, the vehicle sales data accumulated in the vehicle sales DB 300 has items such as “total number of units sold” and “period since the start of mass production” for each “vehicle classification”, as shown in FIG. 10. In this embodiment, the “vehicle classification” is categorized by “vehicle type” and “destination country”.

### (2-4. Terminal Device)

The terminal device 400 is operated by an API administrator who manages the API, and executes at least an API index generation process. The API index generation process is a process of generating an API index used to select APIs that should be prioritized for maintaining backward compatibility when updating many APIs. Maintaining backward compatibility means allowing the existing application that has been used before the update to continue to be used by the updated API.

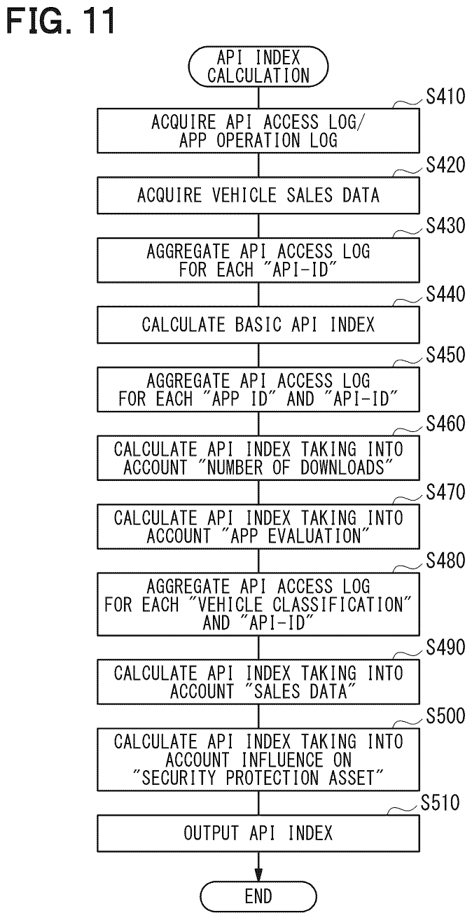

The API index generation process executed by the terminal device 400 will be described with reference to a flowchart of FIG. 11. The evaluation value generation process starts when the terminal device 400 performs an operation to activate the process.

In S410, the terminal device 400 acquires the application operation log and the API access log from the application store 200.

In the next S420, the terminal device 400 acquires the vehicle sales data from the vehicle sales DB 300.

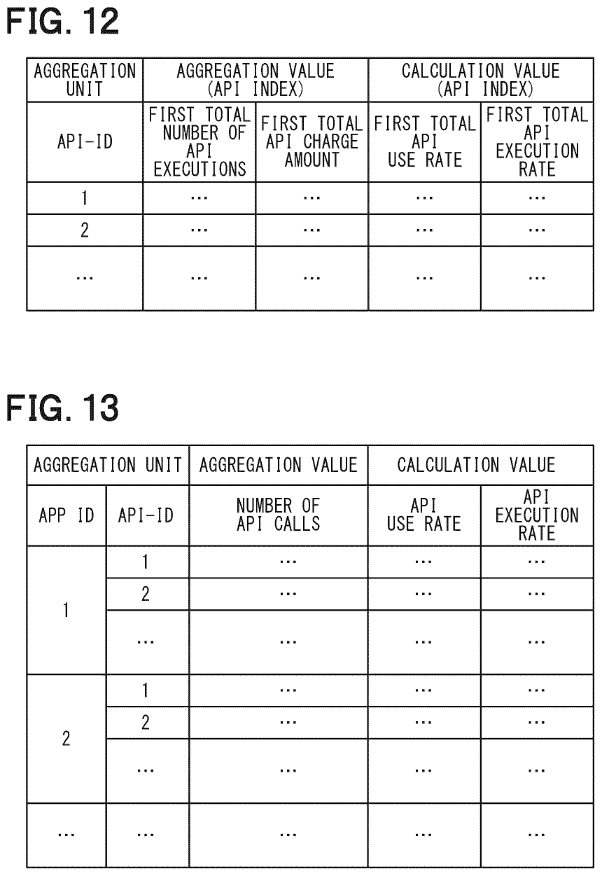

In the next S430, as shown in FIG. 12, the terminal device 400 calculates the “first total number of API executions” and the “first total API charge amount” by aggregating the “number of API calls” and the “API charge amount” in the API access logs for each “API-ID”. The aggregation result and the calculation result may be stored in the RAM 403.

The “API charge amount” is calculated, for example, by aggregating, for each “API-ID”, the “number of API calls, number of API execution completions”, “number of API unnecessary executions”, “number of API abnormal executions”, and “API communication data amount” included in the API access log, and by weighting and summing each aggregation value using predetermined weighting factors. Note that information of the “total API charge amount” may be obtained from an external server that determines the charge amount for each API based on the API access log.

In the next S440, the terminal device 400 calculates the API index based on the aggregation result in S430. Specifically, the terminal device 400 uses the “first total number of API executions” and the “first total API charge amount” as API indices, and further calculates the “first total API use rate” and the “first total API execution rate”.

The “total API use rate” is the number of API uses per application, and is calculated by a first equation using the “number of downloads” included in the application information. However, the cumulative value is used for the “number of downloads”.

$$\begin{matrix}( First Equation ) & \\ “ First total API use rate ” = \frac{“ First total number of API uses ”}{“ Number of downloads ”} & ( 1 )\end{matrix}$$

The “total API execution rate” is the number of API executions per average execution time of one application, and is calculated by a second equation using a “total application execution time” and the “number of downloads” included in the application information. However, the cumulative value is used for the “number of downloads”.

$$\begin{matrix}( Second Equation ) & \\ “ First total API execution rate ” = \frac{“ First total number of API uses ”}{“ Number of downloads ”} & ( 2 )\end{matrix}$$

The API index calculated in this manner simply gives higher evaluations to APIs with a greater number of executions, higher charge amounts, or higher use rates and execution rates, and such APIs are given higher priority for maintaining backward compatibility when the APIs are updated.

In the next S450, as shown in FIG. 13, the terminal device 400 aggregates the “number of API calls” for each “application ID” and “API-ID” in the API access log. Furthermore, in the first and second equations, the “API use rate” and “API execution rate” are calculated for each “application ID” and “API-ID” by using, instead of the “total number of API executions”, the aggregation value of the “number of API calls” in this step. The aggregation result and the calculation result may be stored in the RAM 403.

In the next S460, the terminal device 400 calculates the “second total API use rate” and the “second total API execution rate” based on the “API use rate” and “API execution rate” calculated for each “application ID” and “API-ID” in S450, as well as the “number of downloads” indicated in the application information. The “second total API use rate” and the “second total API execution rate” are API indices that take into account the “number of downloads”.

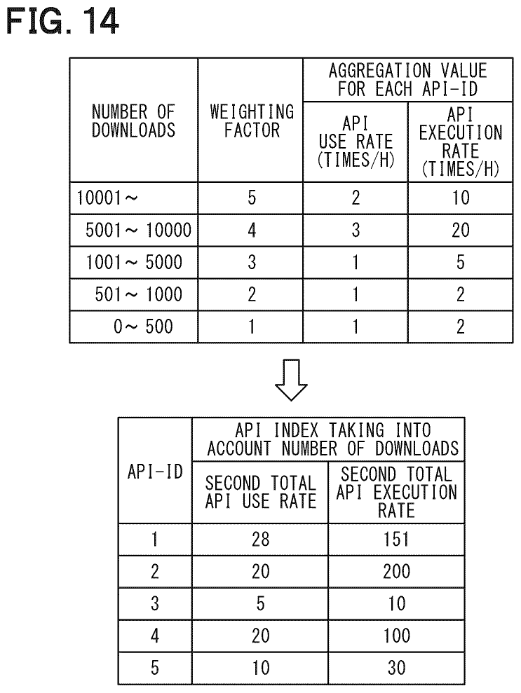

Specifically, as shown in FIG. 14, weighting factors are assigned according to the “number of downloads”, such that a larger “number of downloads” corresponds to a greater value. Here, the number of downloads is classified into five stages from 0 to 500, 501 to 1000, 1001 to 5000, 5001 to 10000, and 10001 to, and the weighting factor of 1 to 5 is assigned. The classification of the number of downloads and the values of the weighting factors (hereinafter referred to as “download-related information”) may be preset, or may be set as needed by an API administrator or the like who operates the terminal device 400. When the download-related information is preset, it may be obtained from, for example, information DB 53 of the application store 200, or may be previously stored in ROM 402. Then, based on the table of FIG. 13, the “API use rate” and the “API execution rate” calculated in S450 are aggregated for each “number of downloads” according to the “application ID”. FIG. 14 shows an example in which one “API-ID” is aggregated. Here, a case of “API-ID”=1 is shown. That is, the same aggregation table as in FIG. 14 will be generated for all “API-IDs”. The aggregation table may be stored in the RAM 403.

In accordance with the aggregation table based on the “number of downloads” shown in the upper part of FIG. 14, weighted summation using the “weighting factors” is performed for each of the “API use rate” and “API execution rate”, thereby calculating, for each “API-ID”, the “second API use rate” and the “second total API use rate”. That is, the “second total API use rate” for “API-ID=1”, as shown in the table at the lower part of FIG. 14, is calculated, in accordance with the table at the upper part of FIG. 14, by the expression of 5×2+4×3+3×1+2×1+1×1. Similarly, the “second total API execution rate” of “API-ID”=1 is calculated by the expression of 5×10+4×20+3×5+2×2+1×2. The calculation result may be stored in the RAM 403.

The API index calculated in such a manner has a high rating for frequently used APIs for applications downloaded to many vehicles, and has a high priority for maintaining backward compatibility when updating APIs. It is assumed that “API-ID”=1 is represented by <1>. In a table in the lower part of FIG. 14, the priority order is <1>→<2>→<4>→<5>→<3> in a case of “weighted summation value of API use ratio”. Further, in a case of “weighted summation value of API execution rate”, the priority order is <2>→<1>→<4>→<5>→<3>.

In the next S470, the terminal device 400 calculates the “second total number of API executions” based on the “API use rate” and the “API execution rate” calculated in S450 for each “application ID” and “API-ID”, and the “application evaluation” indicated in the application information. The “second total number of API executions” is an API index that takes into account the “application evaluation”.

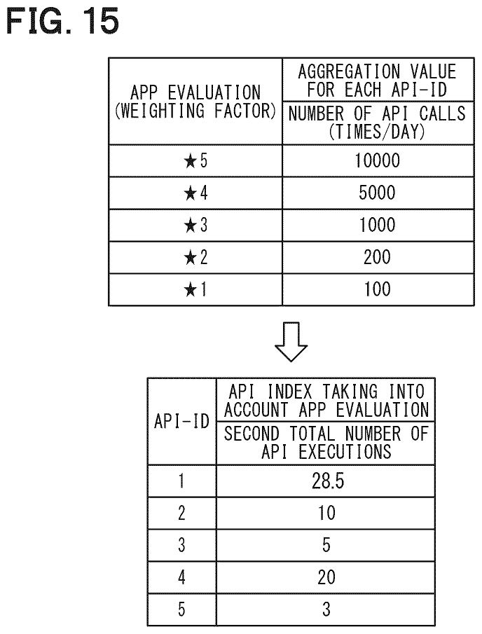

Specifically, as shown in FIG. 15, the “application evaluation”, which becomes a larger value as the evaluation is higher, is used as the “weighting factor” as it is. Here, the weighting factors from 1 to 5 are used. The “weighting factor” may be adjusted each time by the API manager or the like who operates the terminal device 400. Then, with reference to FIG. 7, the aggregation value of the “number of API calls” calculated in S450 is aggregated for each “application evaluation” according to the “application ID”. FIG. 15 shows an example in which aggregation is performed for one “API-ID”. Here, the case of “API-ID”=1 is shown. That is, the same aggregation table as in FIG. 15 will be generated for all “API-IDs”. The aggregation table may be stored in the RAM 403.

In accordance with the aggregation table based on the “application evaluation”, weighted summation for the aggregation values of “number of API calls” is performed using “weighting factors”, thereby calculating, for each “API-ID”, the “second total number of API executions”. That is, the “second total number of API executions” in the case of “API-ID”=1 shown in the lower table of FIG. 15 is calculated by the expression of 5×1000+4×5000+3×1000+2×200+1×100 in accordance with the upper table of FIG. 15. The calculation result may be stored in the RAM 403.

The API indices calculated in this manner give higher evaluations to APIs that are frequently used in applications with high user evaluations, and such APIs are assigned higher priority for maintaining backward compatibility when updating APIs. In a case of the table in the lower row of FIG. 15, the priority order is <1>→<4>→<2>→<3>→<5>.

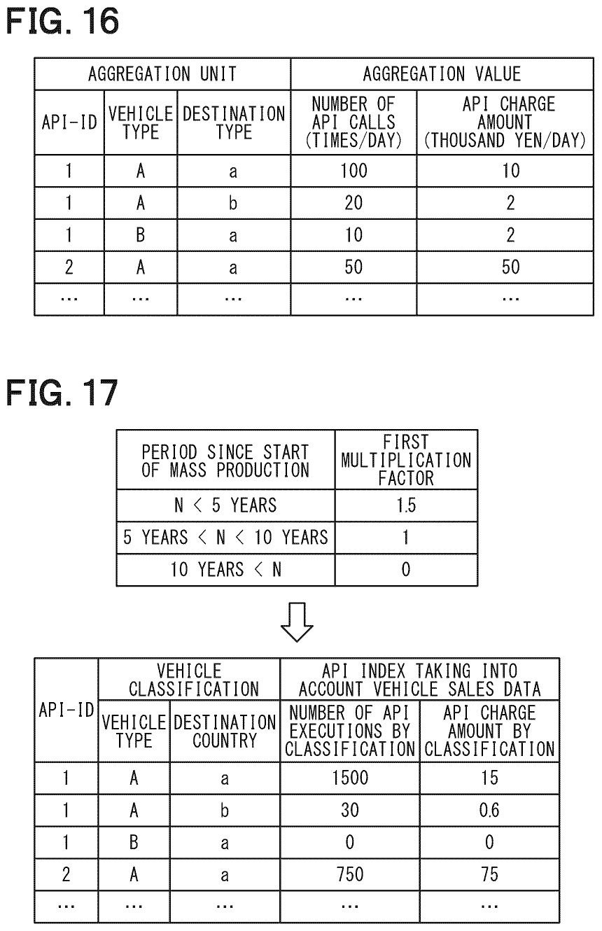

In the next S480, as shown in FIG. 16, the terminal device 400 aggregates, from the API access log, the “number of API calls” and the “API charge amount” for each “API-ID” and each “vehicle classification” (i.e., “vehicle type” and “destination country”). The aggregation result may be stored in the RAM 403.

In the next S490, the terminal device 400 calculates the “number of API executions by classification” and the “API charge amount by classification”, based on the “number of API calls” and the “API charge amount” calculated for each “API-ID” and “vehicle classification” in S480, as well as the “number of units sold” and the “period since the start of mass production” indicated in the vehicle sales data. The “number of API executions by classification” and the “API charge amount by classification” are API indices that take vehicle sales data into consideration.

Specifically, as shown in FIG. 17, a “first multiplication factor” is assigned according to the “period since the start of mass production”, such that the longer the period, the smaller the value of the “first multiplication factor”. In this case, the value is set to 1.5 when the period is less than five years, 1 when the period is five years or more but less than ten years, and 0 when the period is ten years or more. Information (hereinafter referred to as “mass-production period-related information”) indicating how the “first multiplication factor” is assigned may be preset, or may be set as needed by the API administrator or the like who operates the terminal device 400. When the mass-production period-related information is preset, for example, the information stored in the vehicle sales DB 300 or the like may be acquired, or may be stored in advance in the ROM 402. Then, each of the “API use rate” and the “API charge amount” aggregated in S480 is multiplied by the “number of units sold” corresponding to the “vehicle classification” and by the “first multiplication factor” corresponding to the “period since the start of mass production”. Thereby, the “number of executions by classification” and the “charge amount by classification” are calculated for each classification that becomes the aggregation unit.

For example, in the case of “API-ID”=1, “vehicle type”=A, and “destination country”=a shown in a table in the lower part of FIG. 17, the “number of executions by classification” is calculated as follows. Specifically, based on the “total number of units sold” and the “period since the start of mass production” shown in the table of FIG. 10, the “number of API calls” shown in FIG. 16, and the “first multiplication factor” shown in the upper table of FIG. 17, the value is calculated as 100×100,000×1.5. Similarly, the “API charge amount by classification” is calculated as 10,000×100,000×1.5. The calculation result may be stored in the RAM 403.

The API index calculated in such a manner is frequently used in a vehicle classification in which the number of units sold is large and the period from the start of mass production is short. Within the same vehicle classification, the value becomes larger for APIs with higher charge amounts. That is, an API expected to be used frequently in the future is given a higher priority for maintaining backward compatibility when the API is updated. Conversely, when the period since the start of mass production exceeds a predetermined period, a decrease in API use is expected due to vehicle scrapping and the like. Therefore, by setting the “first multiplication factor” to zero, such cases are excluded from evaluation. The aggregation results obtained by aggregating the “number of API executions by classification” and the “API charge amount by classification”, which are calculated as described above for each “API-ID” may be used as the API index.

In the next S500, the terminal device 400 calculates the “third total number of API executions” and the “third total API charge amount”, which are API indices that take into account the “security protection asset”.

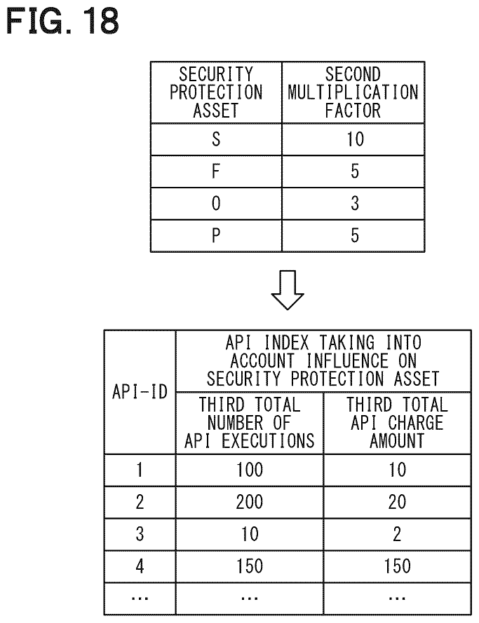

Specifically, as shown in FIG. 18, the “second multiplication factor” is allocated according to the classification of “security protection asset”. Here, S is 10, F is 5, O is 3, and P is 5. Information (hereinafter referred to as protection asset-related information) indicating how to allocate the “second multiplication factor” may be preset, or may be set each time by an API administrator or the like operating the terminal device 400. When the protection asset-related information is preset, for example, the information stored in the information DB 53 of the application store 200 may be acquired or the ROM 402 may store it in advance. Then, the aggregation values of the “number of API calls” and the “API charge amount” aggregated in S430, that is, the “first total number of API executions” and the “first total API charge amount” are multiplied by the “second multiplication factor”. As a result, the “third total number of API executions” and the “third total API charge amount” are calculated for each “API-ID” that serves as the aggregation unit. The calculation result may be stored in the RAM 403.

The API index calculated in such a manner is frequently used, has a high evaluation of the API that affects the perspective of SFOP, and has a high priority for maintaining backward compatibility when the API is updated.

In the next S510, the terminal device 400 outputs the calculated API index to a display screen or the like, and ends the process. Note that the terminal device 400 may transmit the calculated API index to a server that accumulates the API index or to other terminal devices that use the API index.

The API administrator sets the priority for updates that maintain backward compatibility for each API, in accordance with a single selected API index or by combining multiple API indices.

### 3. Correspondence of Terms

In the present embodiment, the “second total API use rate”, the “second total API execution rate”, and the “second total number of API executions” correspond to an application-related index of the present disclosure. In the present embodiment, the “number of API executions by classification” and the “charge amount by classification” correspond to a sales-related index of the present disclosure. In the present embodiment, the “third total number of API executions” and the “third total API charge amount” correspond to a security-related index of the present disclosure. In the present embodiment, S410 to S420 correspond to an information acquisition unit of the present disclosure, S430 to S440 correspond to a basic index generation unit of the present disclosure, and S450 to S470 correspond to an application-related index generation unit of the present disclosure. In the present embodiment, S480 to S490 correspond to a sales-related index generation unit of the present disclosure, S500 corresponds to a security-related index generation unit of the present disclosure, and S510 corresponds to an output unit of the present disclosure. The application store 200 in the present embodiment corresponds to an access log storage of the present disclosure, and the vehicle sales DB 300 corresponds to a sales data storage of the present disclosure.

### 4. Effect

According to the first embodiment described in detail above, the following effects are achieved.

The API evaluation system 1 calculates an API index according to the number of times the API is used and the frequency of use, an API index that takes into account the use status of the application, an API index that takes into account the vehicle sales data, and an API index that takes into account the influence on the security protection assets. By referring to such an API index, it is possible to quantify the influence of each API on the application using the API and the user using the application, and easily select the API that should preferentially maintain backward compatibility based on the degree of the influence.

Here, a specific method for extracting APIs to be developed while maintaining backward compatibility using multiple types of API indices will be described.

For example, first, APIs (hereinafter, first extraction APIs) is extracted from all APIs. The first extraction API has a value of an API index (i.e., “second total API use rate” or “second total API execution rate”) that takes into account the use status of the application. The value is the top 50% of the APIs. That is, the API frequently used in applications used in many vehicles is extracted.

Next, from the first extraction APIs, APIs (hereinafter, second extraction APIs) are extracted. The second extraction API has a value of the API index (i.e., “number of API executions by classification” or “API charge amount by classification”) that takes into account the vehicle sales data. The value is the top 50% of the first extraction APIs. That is, APIs expected to be used in a large number in the future are extracted.

Next, from all APIs, APIs (hereinafter, third extraction APIs) are extracted. The third extraction API has a value of the API index (i.e., “third total number of API executions” or “third total API charge amount”) that takes into account the influence on the security protection assets. The value is the top 20% of the APIs. That is, important APIs are extracted from the perspective of security protection assets.

Finally, the merged APIs based on the second extraction API and the third extraction API are set to APIs that should maintain backward compatibility.

### 5. Other Embodiments

Although the embodiment of the present disclosure has been described above, the present disclosure is not limited to the embodiment described above, and various modifications can be made to implement the present disclosure.
(5a) In the above embodiment, the weighted summation result of the aggregation values of the “API use rate” and the “API execution rate” is used as the API index that takes into account the number of downloads of the application. However, the weighted summation result for the aggregation values of the “number of API calls” may also be used. Further, the weight addition result to the aggregation value of “API call number” is used as the API index that takes into account the “application evaluation”. However, the weighted summation result for the aggregation value of “API use rate” and “API execution rate” may be used.
(5b) In the above embodiment, both of the “number of units sold” and the “first multiplication factor” based on the “period from the start of mass production” are used when calculating the API index that takes into account the vehicle sales data. However, either the “number of units sold” or the “first multiplication factor” may be used. Alternatively, instead of using the “number of units sold” as it is, the “third multiplication factor” set according to the number of units sold may be used.
(5c) In the above embodiment, the API index that takes into account the security protection assets is not limited to the “first total number of API executions” and the “first API total charge amount”. The API index that takes into account the security protection assets may be generated, for example, by multiplying any API index other than the “first total number of API executions” and the “first total API charge amount” by a “second multiplication factor”.
(5d) The in-vehicle devices 2 to 5, the application store 200, the vehicle sales DB 300, the terminal device 400 (hereinafter referred to as a control device group), and the method described in the present disclosure may be implemented by a dedicated computer provided by a memory and a processor programmed to execute one or more functions embodied by a computer program of the memory. Alternatively, the control device group and the method described in the present disclosure may be implemented by a dedicated computer provided by a processor with one or more dedicated hardware logic circuits. Alternatively, the control device group and the method described in the present disclosure may be implemented by one or more dedicated computers provided by a combination of a processor and a memory programmed to execute one or more functions and a processor including one or more hardware logic circuits. The computer program may be stored in a computer-readable non-transitory tangible storage medium as an instruction to be executed by the computer. The method for implementing the functions of the respective units included in the control device group does not necessarily need to include software, and all of the functions may be implemented with the use of one or multiple hardware.
(5e) The multiple functions of one component in the above embodiment may be implemented by multiple components, or a function of one component may be implemented by multiple components. In addition, multiple functions of multiple components may be implemented by one component, or a single function implemented by multiple components may be implemented by one component. Part of the configuration of the above embodiment may be omitted. At least a part of the configuration in one embodiment may be added to or substituted for the configuration of another embodiment.

(5f) In addition to the API evaluation system described above, the present disclosure may be implemented in various forms such as a system having the API evaluation system as a component, a program for causing the computer to function as the API evaluation system, a non-transitory tangible storage medium such as a semiconductor memory for storing the program, and an API evaluation index generation method.

What is claimed is:

1. An application programming interface evaluation system comprising:
at least one of (i) a circuit and (ii) a processor with a memory storing computer program code executable by the processor, the at least one of the circuit and the processor configured to cause the application programming interface evaluation system to:
acquire an application programming interface access log representing a use status of an application programming interface that is an interface for providing a vehicle function according to a request from an application installed in a vehicle;
generate a sales-related index that is an application programming interface index indicating a degree of an influence of the application programming interface on the application and a user of the vehicle, according to a log aggregation value that is a result of aggregating the application programming interface access log for each vehicle classification obtained by classifying the vehicle based on vehicle sales data related to sales of the vehicle and for each type of the application programming interface; and
output the sales-related index.

2. An application programming interface evaluation system comprising:
an access log storage configured to collect from a vehicle and store an application programming interface access log representing a use status of an application programming interface that is an interface for providing a vehicle function according to a request from an application installed in the vehicle;
a sales data storage configured to accumulate vehicle sales data related to sales of the vehicle; and
at least one of (i) a circuit and (ii) a processor with a memory storing computer program code executable by the processor, the at least one of the circuit and the processor configured to cause the application programming interface evaluation system to:
acquire the application programming interface access log and the vehicle sales data from the access log storage and the sales data storage;
generate a sales-related index that is an application programming interface index indicating a degree of an influence of the application programming interface on the application and a user of the vehicle, according to a log aggregation value that is a result of aggregating the application programming interface access log for each vehicle classification obtained by classifying the vehicle based on the vehicle sales data and for each type of the application programming interface; and
output the sales-related index.

3. The application programming interface evaluation system according to claim 2, wherein
the at least one of the circuit and the processor is further configured to cause the application programming interface evaluation system to calculate the sales-related index by multiplying a multiplication factor set according to the vehicle sales data by the log aggregation value aggregated for each vehicle classification and each type of the application programming interface.

4. The application programming interface evaluation system according to claim 2, wherein
the vehicle classification is set using at least one of a vehicle type of the vehicle or a sales region of the vehicle.

5. The application programming interface evaluation system according to claim 2, wherein
the vehicle sales data includes at least one of a numerical number of units sold of the vehicle or a period from a start of mass production of the vehicle.

6. The application programming interface evaluation system according to claim 2, wherein
the log aggregation value includes at least one of a numerical number of application programming interface calls or an application programming interface charge amount,
the numerical number of the application programming interface calls is a numerical number of times the application programming interface is called by the application, and
the application programming interface charge amount is imposed on a provider of the application according to a communication data amount associated with use of the application programming interface.

7. The application programming interface evaluation system according to claim 2, wherein
the at least one of the circuit and the processor is further configured to cause the application programming interface evaluation system to further acquire data indicating whether the influence is present on a security protection asset for each type of the application programming interface, and
the application programming interface evaluation system further comprises at least one of (i) a different circuit and (ii) a different processor with a different memory storing different computer program code executable by the different processor, the at least one of the different circuit and the different processor configured to cause the application programming interface evaluation system to multiply a multiplication factor set for each classification of the security protection asset by the log aggregation value to generate a security-related index that is an application programming interface index that takes into account the influence on the security protection asset.

8. The application programming interface evaluation system according to claim 2, wherein
the at least one of the circuit and the processor is further configured to cause the application programming interface evaluation system to further acquire an application operation log including a numerical number of executions and an execution time of the application installed in the vehicle,
the log aggregation value includes at least one of an application programming interface use rate that is a numerical number of uses of the application programming interface per the application or an application programming interface execution rate that is a numerical number of uses of the application programming interface per an average execution time of the application, and
the application programming interface evaluation system further comprises at least one of (i) a different circuit and (ii) a different processor with a different memory storing different computer program code executable by the different processor, the at least one of the different circuit and the different processor configured to cause the application programming interface evaluation system to generate an application-related index that is an application programming interface index that takes into account the use status of the application, according to the log aggregation value that is the result of aggregating the application programming interface access log for each application type and for each type of the application programming interface.

9. The application programming interface evaluation system according to claim 8, wherein
the at least one of the different circuit and the different processor is further configured to cause the application programming interface evaluation system to generate the application-related index by weighted summation of the log aggregation value using a weighting factor set for each type of the application according to a cumulative value of the application downloaded to the vehicle.

10. The application programming interface evaluation system according to claim 8, wherein
the at least one of the different circuit and the different processor is further configured to cause the application programming interface evaluation system to generate the application-related index by weighted summation of the log aggregation value using a weighting factor set for each type of the application according to a user application evaluation for the application.

11. The application programming interface evaluation system according to claim 2, wherein
the at least one of the circuit and the processor is further configured to cause the application programming interface evaluation system to generate a basic index that is an application programming interface index that takes into account the use status of the application programming interface according to the log aggregation value that is the result of aggregating the application programming interface access log for each type of the application programming interface.

12. A non-transitory computer-readable storage medium storing a program causing a computer to:
acquire an application programming interface access log representing a use status of an application programming interface that is an interface that provides a function of a vehicle according to a request from an application installed in the vehicle;
generate a sales-related index that is an application programming interface index indicating a degree of influence of the application programming interface on the application and a user of the vehicle, according to a log aggregation value that is a result of aggregating the application programming interface access log for each vehicle classification obtained by classifying the vehicle based on vehicle sales data related to sales of the vehicle and for each type of the application programming interface; and
output the sales-related index.
